(19) United States
(12) Patent Application Publication
(10) Pub. No.: US 2023/0091669 A1
(43) Pub. Date: Mar. 23, 2023

(54) INFORMATION PROCESSING APPARATUS, INFORMATION PROCESSING SYSTEM, AND NON-TRANSITORY COMPUTER READABLE MEDIUM STORING PROGRAM

(71) Applicant: FUJIFILM Business Innovation Corp., Tokyo (JP)

(72) Inventor: Ryosuke SUZUKI, Kanagawa (JP)

(73) Assignee: FUJIFILM Business Innovation Corp., Tokyo (JP)

(21) Appl. No.: 17/575,592

(22) Filed: Jan. 13, 2022

(30) Foreign Application Priority Data
Sep. 22, 2021 (JP) 2021-154793

(51) Int. Cl. G06F 3/16; G06V 40/10; G06V 40/20; G06F 3/01; G06V 20/00; H04R 3/00; G10K 11/178

(52) U.S. Cl. CPC G06F 3/165; G06V 40/10; G06V 40/20; G06F 3/011; G06V 20/00; H04R 3/00; G10K 11/1787; H04R 2430/01

(57) ABSTRACT

An information processing apparatus includes a processor configured to: manage information on an object to be recognized and control content of a function of a speaker device placed near a user's ear in association with each other; and control the function of the speaker device, according to the control content of the function of the speaker device associated with the information on the object to be recognized, in a case where the object is recognized based on a result of sensing indicating at least one of a situation of the user or a situation around the user.

### CROSS-REFERENCE TO RELATED APPLICATIONS

This application is based on and claims priority under 35 USC 119 from Japanese Patent Application No. 2021-154793 filed Sep. 22, 2021.

### BACKGROUND

### (i) Technical Field

The present invention relates to an information processing apparatus, an information processing system, and a non-transitory computer readable medium storing a program.

### (ii) Related Art

In recent years, the functions of wireless earphones and headphones have been enhanced, and in particular, functions that change the listening comfort of sounds, such as a function of removing noise and a function of allowing the surrounding sounds to be heard naturally, are attracting attention, and there are also related techniques (for example, JP2020-108166A).

### SUMMARY

However, in order for the user to enjoy the benefits of the functions that change the listening comfort of sounds, it is necessary for the user to perform an operation of enabling or disabling these functions by himself or herself, and could not fully enjoy the benefits of these functions.

Aspects of non-limiting embodiments of the present disclosure relate to an information processing apparatus, an information processing system, and a non-transitory computer readable medium storing a program, which enable a user who has placed a speaker device having a function that changes the listening comfort of sounds near his or her ear to enjoy the benefits of the function more than a case where the user performs an operation for enjoying the benefits of the function by himself or herself.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to: manage information on an object to be recognized and control content of a function of a speaker device placed near a user's ear in association with each other; and control the function of the speaker device, according to the control content of the function of the speaker device associated with the information on the object to be recognized, in a case where the object is recognized based on a result of sensing indicating at least one of a situation of the user or a situation around the user.

### BRIEF DESCRIPTION OF THE DRAWINGS

Exemplary embodiment(s) of the present invention will be described in detail based on the following figures, wherein:

FIG. 1 is a diagram showing an overall configuration of an information processing system to which the present exemplary embodiment is applied;

FIG. 2 is a diagram showing a hardware configuration of a user terminal;

FIG. 3 is a diagram showing a hardware configuration of AR glasses;

FIG. 4 is a diagram showing a functional configuration of a control unit of the user terminal;

FIG. 5 is a diagram showing a functional configuration of a control unit of the AR glasses;

FIG. 6 is a flowchart showing a processing flow from recognizing an object to controlling the function of an earphone device, among processes of the user terminal;

FIG. 7 is a flowchart showing a processing flow in a case of controlling the function of the earphone device;

FIG. 8 is a flowchart showing a processing flow of the AR glasses;

FIG. 9 is a diagram showing a specific example of information stored in a database of a storage unit of the user terminal; and

FIG. 10 is a diagram showing evaluation results regarding the ability and suitability of each of a plurality of types of sensors and cameras mounted on the sensor unit and the imaging unit of the AR glasses.

### DETAILED DESCRIPTION

Configuration of Information Processing System

Hereinafter, an exemplary embodiment of the present invention will be described in detail with reference to the accompanying drawings.

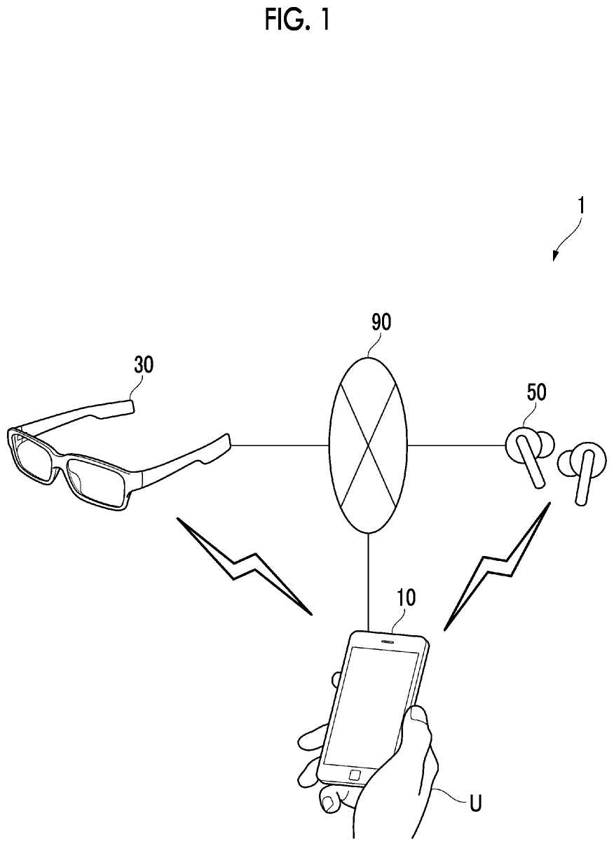

FIG. 1 is a diagram showing an overall configuration of an information processing system 1 to which the present exemplary embodiment is applied.

In the information processing system 1, a user terminal 10, augmented reality (AR) glasses 30, and an earphone device 50 are connected via a network 90, or according to a communication scheme such as infrared communication, visible light communication, proximity wireless communication, Bluetooth (registered trademark), RFID (registered trademark), or an Ultra Wide Band (UWB). The network 90 is, for example, a local area network (LAN), the Internet, or the like. It is assumed that the user terminal 10, the AR glasses 30, and the earphone device 50 have completed the so-called pairing process and are registered as candidates for connection to each other.

The user terminal 10 is an information processing apparatus such as a smartphone, a tablet terminal, or a personal computer used by the user U. The user terminal 10 manages information on an object to be recognized and the control content of the function of the earphone device 50 mounted on the ear of the user U in association with each other. The user terminal 10 recognizes an object based on the result of sensing indicating at least one of the situation of the user U wearing the earphone device 50 or the situation around the user U. Then, the user terminal 10 controls the function of the earphone device 50, according to the control content of the function of the earphone device 50 associated with the information on the recognized object.

The AR glasses 30 are a glasses-type wearable terminal having a display for displaying image information, and is worn on the head of the user U. The AR glasses 30 display image information on a display and makes an object present in the real space visible through the display. The AR glasses 30 are equipped with a plurality of types of sensors capable of detecting objects present in the front, rear, and side direction, and the sensing results of these sensors are transmitted to the user terminal 10 in real time.

The earphone device 50 is a speaker device that outputs sounds such as music, and is mounted on both ears of the user U. The earphone device 50 has a function of changing the listening comfort of sound. For example, the earphone device 50 has a function of capturing external sounds, a function of cancelling external sounds, a function of stopping the sound output, a function of adjusting a volume, a function of outputting a message indicating that the object has been recognized by the user terminal 10, and the like. Among these functions, the function of capturing external sounds refers to a function of reducing the volume of the output sound and capturing the sound around the user U.

Further, the function of cancelling external sounds is also referred to as a so-called active noise cancelling function, which is a function that reduces ambient noise and makes it possible to enjoy sounds with a sense of realism. Specifically, the function of cancelling external sounds is a function of separately generating a signal having a phase opposite to the external sound by using a digital circuit or an analog circuit, and actively attenuating the external sound by superimposing the generated signal. These functions can be controlled by input operations to the earphone device 50 or the user terminal 10, but in the present exemplary embodiment, the functions are automatically controlled by the functional configuration of the user terminal 10 described later.

The above-described function of each information processing apparatus is an example, and the information processing system 1 as a whole may have the above-described function. Therefore, a part or all of the above-described functions may be shared or cooperated in the information processing system 1. For example, a part or all of the functions of the AR glasses 30 may be the functions of the user terminal 10 or the earphone device 50. Thus, the processing of the information processing system 1 as a whole can be promoted, and the processing can be complemented by each other.

Hardware Configuration Of User Terminal

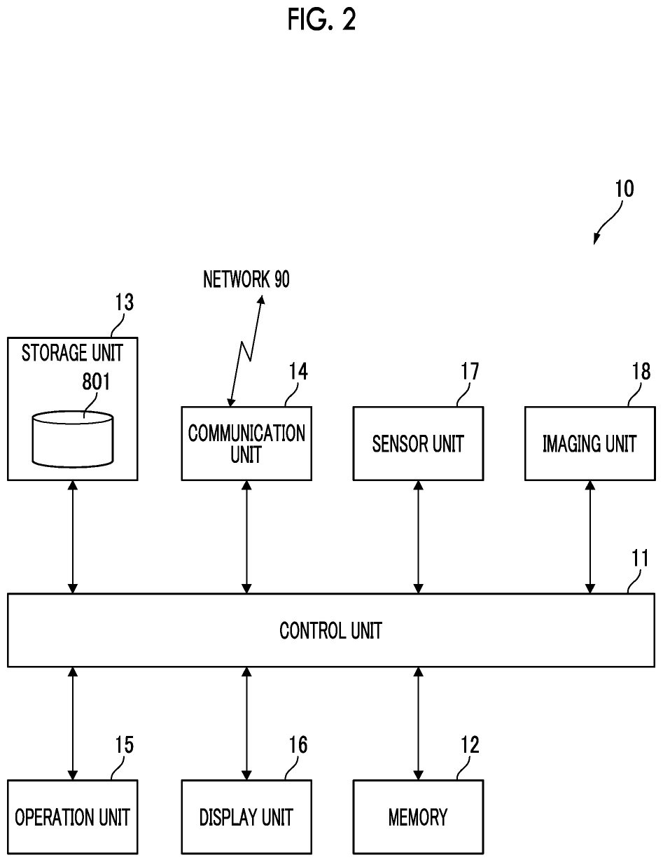

FIG. 2 is a diagram showing a hardware configuration of the user terminal 10.

The user terminal 10 includes a control unit 11, a memory 12, a storage unit 13, a communication unit 14, an operation unit 15, a display unit 16, a sensor unit 17, and an imaging unit 18. Each of these units is connected by a data bus, an address bus, a Peripheral Component Interconnect (PCI) bus, or the like.

The control unit 11 is a processor that controls the operation of the user terminal 10 by executing various types of software such as OS (basic software) and application software. The control unit 11 is, for example, a central processing unit (CPU). The memory 12 is a storage area for storing various types of software, data used for executing the software, and the like, and is used as a work area for calculation. The memory 12 is, for example, a Random Access Memory (RAM), or the like.

The storage unit 13 is a storage area for storing input data for various types of software, output data from various types of software, and the like, and stores a control content DB 801 as a database for storing various types of information. The information stored in the control content DB 801 will be described later. The storage unit 13 is composed of, for example, a Hard Disk Drive (HDD), a Solid State Drive (SSD), a semiconductor memory, or the like used for storing programs, various setting data, and the like. The communication unit 14 transmits or receives data via the network 90. The communication unit 14 transmits or receives data via the network 90 or by a communication scheme such as infrared communication. The communication unit 14 transmits or receives data to or from the AR glasses 30 and the earphone device 50.

The operation unit 15 is composed of, for example, a keyboard, a mouse, mechanical buttons, and switches, and receives input operations. The operation unit 15 also includes a touch sensor that integrally configures a touch panel with the display unit 16. The display unit 16 displays an image, text information, or the like. The display unit 16 is composed of, for example, a liquid crystal display or an organic electro luminescence (EL) display used for displaying information.

Hardware Configuration of AR Glasses

The sensor unit 17 is composed of various sensors such as an ambient light sensor, a proximity sensor, an optical sensor such as light detection and ranging (LiDAR), and an acceleration sensor. The imaging unit 18 is composed of a camera capable of capturing still images and moving images, an infrared camera, and the like. Each of these units is connected by a data bus, an address bus, a PCI bus, or the like.

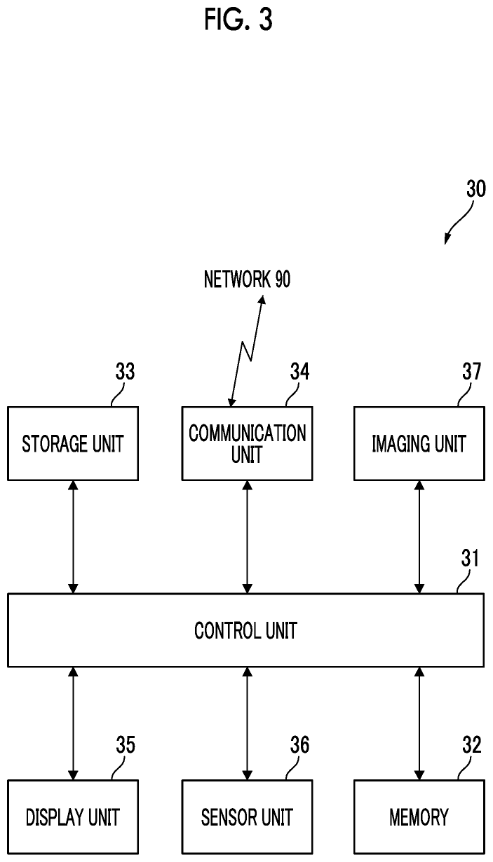

FIG. 3 is a diagram showing a hardware configuration of the AR glasses 30.

The AR glasses 30 have the same hardware configuration as the hardware configurations of the user terminal 10 shown in FIG. 2 other than the configuration of the operation unit 15. That is, the AR glasses 30 have a control unit 31 composed of a processor such as a CPU, a memory 32 composed of a storage area such as a RAM, and a storage unit 33 composed of a storage area such as an HDD, an SSD, or a semiconductor memory. Further, the AR glasses 30 have a communication unit 34 that transmits and receives data to and from the user terminal 10 and the earphone device 50 via the network 90 and the like, and a display unit 35 composed of a liquid crystal display, an organic EL display, and the like. Further, the AR glasses 30 have a sensor unit 36 including a LiDAR, a millimeter-wave radar, an acceleration sensor, and the like, and an imaging unit 37 including a camera capable of capturing still images and moving images, an infrared camera, and the like. Each of these units is connected by a data bus, an address bus, a PCI bus, or the like.

In the above configuration, the sensor unit 36 and the imaging unit 37 can detect and image an object present in each of the front, rear, and side direction of the AR glasses 30. The LiDAR that configures the sensor unit 36 detects an object and measures the distance by using light, and each of the millimeter-wave radars measures the position and speed of the object by using radio waves. Further, the camera that configures the imaging unit 37 enables the detection of an object from the analysis result of the data of the captured image.

Functional Configuration of Control Unit of User Terminal

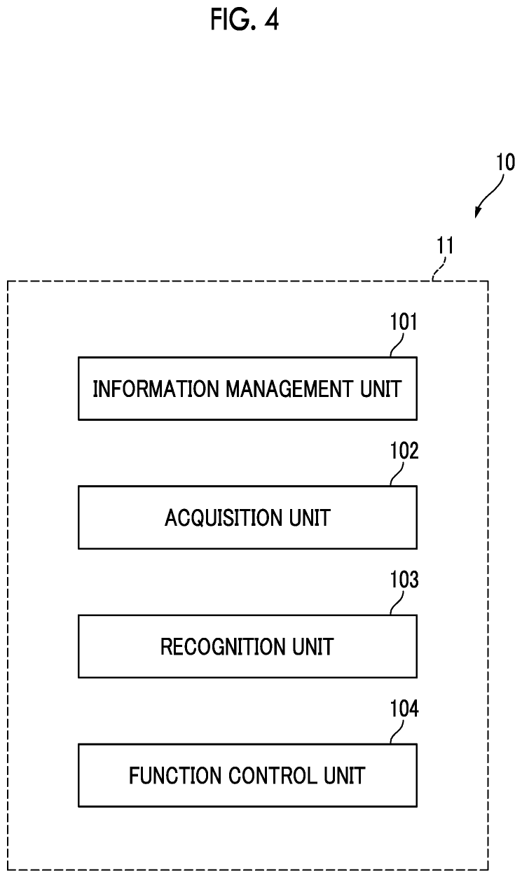

FIG. 4 is a diagram showing a functional configuration of the control unit 11 of the user terminal 10.

In the control unit 11 of the user terminal 10, the information management unit 101, the acquisition unit 102, the recognition unit 103, and the function control unit 104 function.

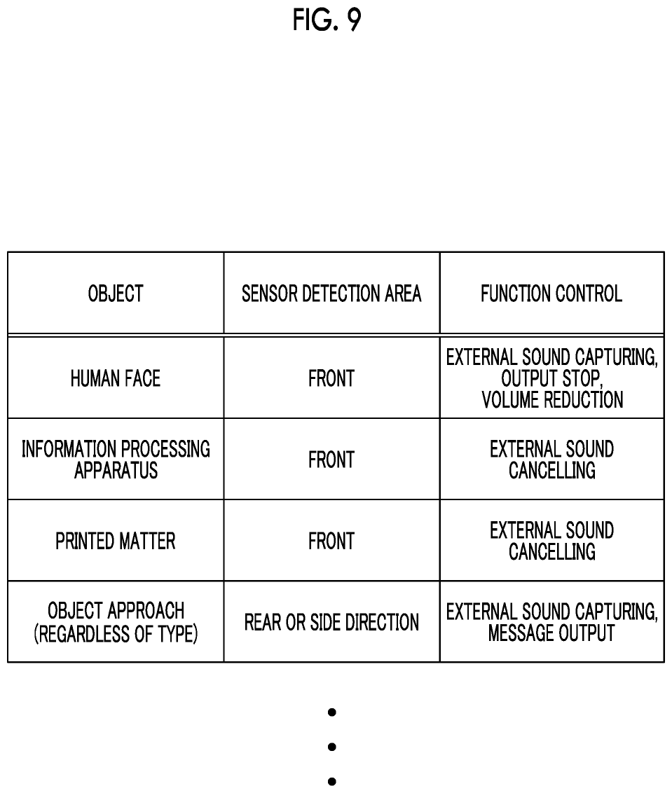

As a management unit, the information management unit 101 stores and manages the information on the object to be recognized and the control content of the function of the earphone device 50 mounted on the ear of the user U in a database in association with each other. Specifically, the information management unit 101 stores and manages information on an object that may be present around the user wearing the earphone device 50 and information on the user as an object and the control content of the function of the earphone device 50 in the control content DB 801 of the storage unit 13 in association with each other. The information on the object that may be present around the user U wearing the earphone device 50 includes information indicating the positional relationship between the user U and the object. Further, the information on the user U as an object includes the information on the behavior of the user U. Specific examples of the information on the object to be recognized and the control content of the function of the earphone device 50 mounted on the ear of the user U will be described later with reference to FIG. 9.

The acquisition unit 102 acquires the sensing result transmitted from the AR glasses 30 mounted on the user U and the information indicating the position of the AR glasses 30. The sensing result transmitted from the AR glasses 30 includes a sensing result indicating the situation of the user U and a sensing result indicating the situation around the user U.

Examples of the information indicating the position transmitted from the AR glasses 30 include Global Positioning System (GPS) information of the AR glasses 30. Further, the acquisition unit 102 acquires information indicating the position of the user terminal 10. Examples of the information indicating the position of the user terminal 10 include GPS information of the user terminal 10.

The recognition unit 103 recognizes the object based on the information including at least the sensing result acquired by the acquisition unit 102. The sensing result acquired by the acquisition unit 102 is a bundle of sensing results of each of the plurality of types of sensors mounted on the AR glasses 30. Therefore, in a case of recognizing an object, the recognition unit 103 selects a bundle of acquired sensing results and recognizes the object based on a combination of sensing results suited for recognizing the object. In a case of selecting the sensing result, the recognition unit 103 considers an ability to recognize an object, an ability to respond to an environment, an ability to measure a distance, an ability to recognize a space, and an ability to measure a speed, or the like of each of the plurality of types of sensors and cameras mounted on the AR glasses 30.

The recognition unit 103 can recognize an object based on information in which the combination of the selected sensing results and the usage environment of the earphone device 50 estimated from the information indicating the positions of the user terminal 10 and the AR glasses 30 are combined. In this way, by enabling the object to be recognized based on the information regarding the positions of the user terminal 10 and the AR glasses 30, it is possible to complement the recognition results of the object based only on the sensing results.

The recognition unit 103 recognizes that a human being, as an object around the user U, is present in front of the user U, based on the information including at least the combination of the acquired sensing results. Further, the recognition unit 103 recognizes that the human being, present in front of the user U, speaks to the user U. Here, there is no particular limitation on how to recognize a human being, present in front of the user U, is speaking to user U. For example, it may be recognized that the human being is speaking to the user U, by detecting the change in facial expression or the movement of the mouth from the sensing results based on the data of the image of the face of the human being present in front of the user U.

Further, the recognition unit 103 recognizes that another information processing apparatus or printed matter as an object around the user U is present in front of the user U, based on the information including at least the combination of the acquired sensing results. For example, it is conceivable that the user U sits on a chair and starts operating a personal computer or browsing a book or a material.

Further, the recognition unit 103 recognizes that an object around the user U is present in the rear of or in a side direction of the user U, based on the information including at least the combination of the acquired sensing results. For example, a situation may be considered in which some object approaches behind or on both sides of the walking user U. Further, the recognition unit 103 recognizes the behavior of the user U as an object. Examples of the behavior of the user U include turning around, looking up, and bowing. In this case, the combination of the pattern of the behavior of the user U and the sensing result may be modeled. This makes it possible to recognize the behavior of the user with higher accuracy.

In a case where an object is recognized by the recognition unit 103 as a control unit, the function control unit 104 performs control of the function of the earphone device 50, according to the control content of the function stored in the control content DB 801 and associated with information on the recognized object. Specifically, the function control unit 104 controls the function of the earphone device 50, according to a content of at least one of the control for capturing external sounds, the control for cancelling external sounds, the control for stopping sound output, the control of adjusting a volume, or the control for outputting a message indicating that an object is recognized, as the control content of the function. From the viewpoint of prioritizing the user U's risk avoidance, the function control unit 104 can perform control that prioritizes capturing external sounds, stopping sound output, and reducing a volume over cancelling external sounds, as the control of the function of the earphone device 50.

For example, in a case where it is recognized that a human being as an object around the user U is present in front of the user U, the function control unit 104 performs control one or more of capturing external sounds, stopping the sound output, and reducing a volume, as the control of the function of the earphone device 50. Further, in a case where it is recognized that a human being, as an object around the user U, is present in front of the user U and is speaking to the user U, the function control unit 104 performs control one or more of capturing external sounds, stopping the sound output, and reducing a volume, as the control of the function of the earphone device 50.

Further, for example, in a case where it is recognized that another information processing apparatus or printed matter as an object around the user U is present in front of the user U, the function control unit 104 performs control for cancelling external sounds, as the control of the function of the earphone device 50. Further, for example, in a case where it is recognized that an object around the user U is present in the rear of or in a side direction of the user U, the function control unit 104 performs control of at least one of the capturing of external sounds, or the outputting a message by sound or text, as the control of the function of the earphone device 50.

Further, for example, in a case where the behavior of the user U as an object is recognized, the function control unit 104 performs at least one or more controls of capturing external sounds, cancelling external sounds, stopping the sound output, adjusting a volume, or outputting a message indicating that the object is recognized, as the control of the function of the earphone device 50. Further, for example, in a case where turning around, looking up, or nodding and bowing is recognized as the behavior of the user U as an object, the function control unit 104 performs control of one or more of the capturing of external sounds, stopping the sound output, and reducing a volume, as the control of the function of the earphone device 50.

Further, the function control unit 104 controls various functions of the earphone device 50 based on the information regarding the positions of the user terminal 10 and the AR glasses 30. For example, in a case where the user is in a facility or place (for example, a platform of a station, a hospital, or the like) where there is an announcement for the user, the function control unit 104 performs control for capturing external sounds. Further, in a case where the user is moving on the train, the function control unit 104 performs control for cancelling external sounds. These content are stored in the above-described database and are used to control the functions, and the user U can edit this database such as modification, addition, and deletion. Further, in a case where the user U manually switches the function control, the situation obtained from the acquisition unit 102 can be added to this database.

Functional Configuration Of AR Glasses

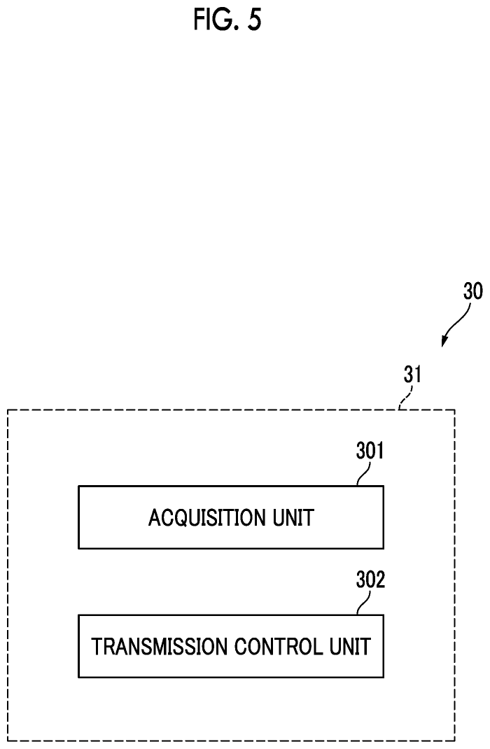

FIG. 5 is a diagram showing a functional configuration of the control unit 31 of the AR glasses 30.

In the control unit 31 of the AR glasses 30, the acquisition unit 301 and the transmission control unit 302 function.

The acquisition unit 301 acquires the result of sensing by the sensor unit 36 and the imaging unit 37 of the AR glasses 30. The transmission control unit 302 performs control to transmit the sensing result acquired by the acquisition unit 301 to the user terminal 10.

Processing Of User Terminal

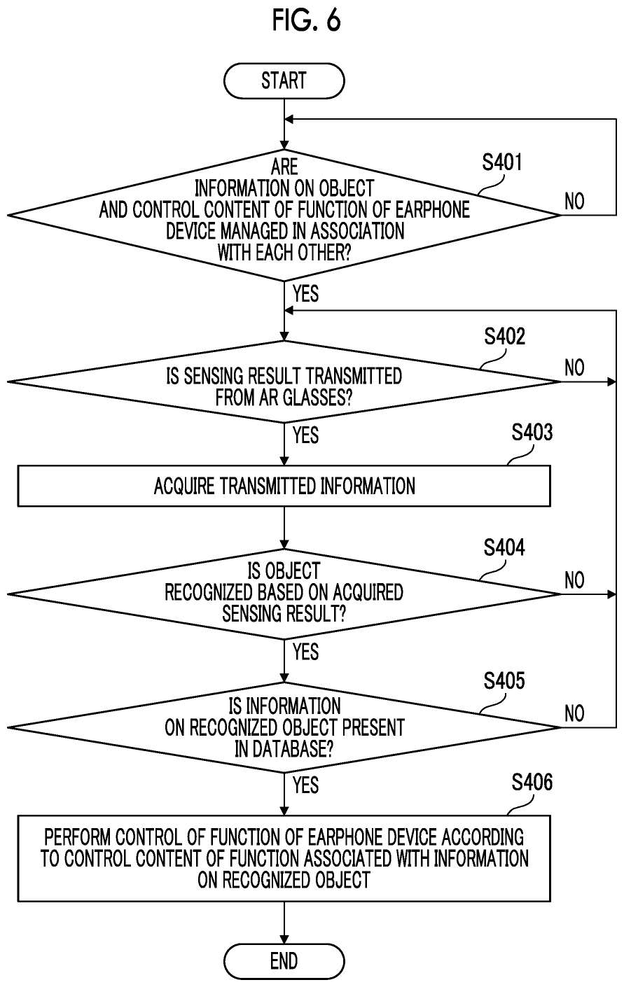

FIG. 6 is a flowchart showing a processing flow from recognizing an object to controlling the function of the earphone device 50, among processes of the user terminal 10.

In a case where the information on the object and the control content of the function of the earphone device 50 are managed in association with each other (YES in step S401), and the sensing result is transmitted from the AR glasses 30 (YES in step S402), the user terminal 10 acquires the transmitted information (step S403). On the other hand, in a case where the information on the object and the control content of the function of the earphone device 50 are not managed in association with each other (NO in step S401), the process of step S401 is repeated until the information on the object and the control content of the function of the earphone device 50 are managed in association with each other. In a case where the sensing result has not been transmitted from the AR glasses 30 (NO in step S402), the user terminal 10 repeats the process of step S402 until the sensing result is transmitted from the AR glasses 30.

In a case where the user terminal 10 recognizes the object based on the sensing result acquired in step S403 (YES in step S404), and the information on the recognized object is present in the database (YES in step S405) , the user terminal 10 performs control of the function of the earphone device 50 according to the control content of the function associated with the information on the recognized object (step S406). On the other hand, in a case where the object is not recognized based on the sensing result acquired in step S403 (NO in step S404), or the information on the recognized object is not present in the database (NO in step S405), the process returns to step S402.

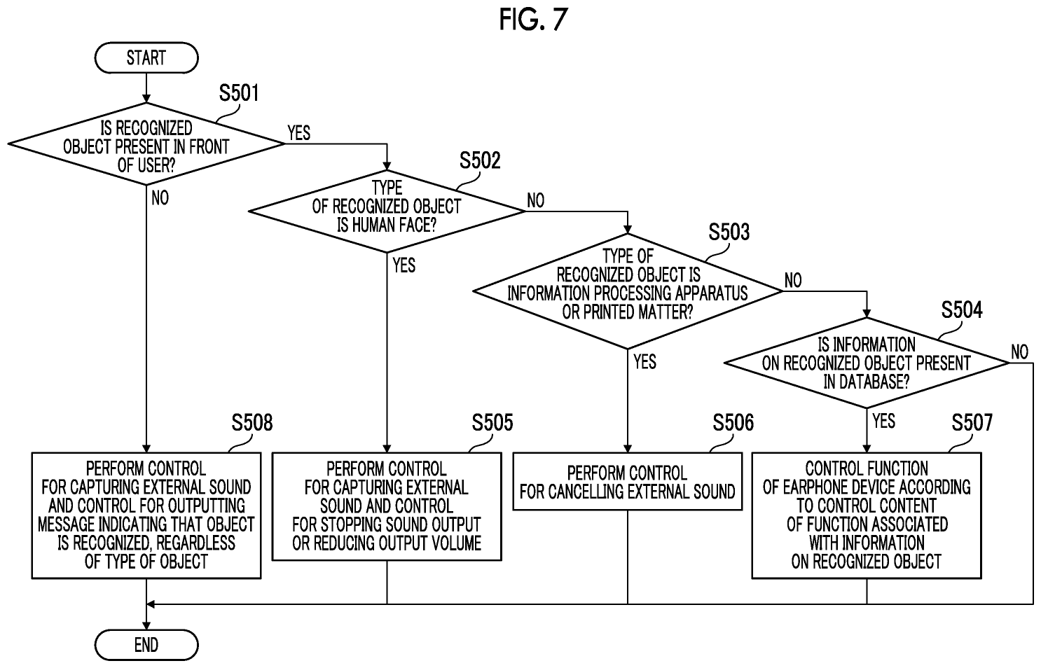

FIG. 7 is a flowchart showing a processing flow in a case of controlling the function of the earphone device 50.

In a case where the recognized object is present in front of the user U (YES in step S501) and the type of the object is a human face (YES in step S502), the user terminal 10 performs control for capturing external sounds, and control for stopping the sound output or reducing an output volume, as the control of the function of the earphone device 50 (step S505). Specifically, as the control for capturing external sounds, control for switching the switch of the function for capturing external sounds, mounted on the earphone device 50, from OFF to ON is performed, and control for stopping the playback of the music or the like output from the earphone device 50 or reducing the volume is performed.

Further, in a case where the recognized object is present in front of the user U (YES in step S501), the type of the object is not a human face (NO in step S502) but is an information processing apparatus or a printed matter (YES in step S503), the user terminal 10 performs control for cancelling external sounds, as the control of the function of the earphone device 50 (step S506). Specifically, as the control for cancelling external sounds, control for switching the switch of a so-called active noise cancelling function from OFF to ON is performed.

On the other hand, in a case where the recognized object is not an information processing apparatus or a printed matter (NO in step S503), and the information on the recognized object is present in the database (YES in step S504), the function of the earphone device 50 is controlled according to the control content of the function associated with the information on the object (step S507). Specifically, in a case where the information on the recognized object is present in the control content DB 801 of the storage unit 13, the function of the earphone device 50 is controlled according to the control content of the function associated with the information on the object. On the other hand, in a case where the information on the recognized object is not present in the database (NO in step S504), the process ends.

Further, in a case where the recognized object is present not in front of the user U but in the rear of or in a side direction (NO in step S501), the user terminal 10 performs the control for capturing external sounds and the control for outputting a message indicating that the object is recognized, regardless of the type of the object, as the control of the function of the earphone device 50 (step S508). For example, as the control for outputting a message indicating that an object has been recognized, a control such as notification by a warning sound is performed.

Processing Of AR Glasses

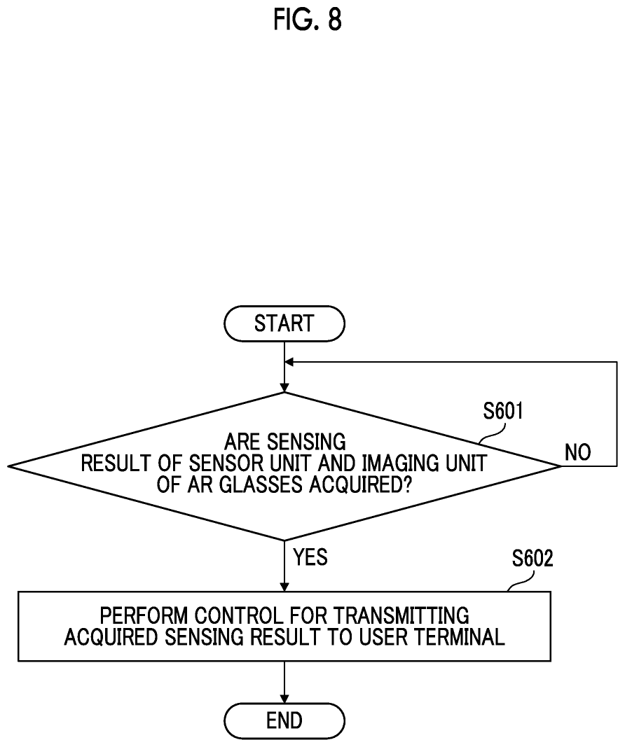

FIG. 8 is a flowchart showing a processing flow of the AR glasses 30.

In a case where the AR glasses 30 acquire the sensing result of the sensor unit 36 and the imaging unit 37 of the AR glasses 30 (YES in step S601), the AR glasses 30 transmit the sensing result to the user terminal 10 (step S602). On the other hand, in a case where the sensing result is not acquired (NO in step S601), the AR glasses 30 repeat the process of step S601 until the sensing results of the sensor unit 36 and the imaging unit 37 of the AR glasses 30 are acquired.

Specific Example

FIG. 9 is a diagram showing a specific example of information stored in the database of the storage unit 13 of the user terminal 10.

As described above, the control content DB 801 stored in the storage unit 13 of the user terminal 10 stores the information on the object that may be present around the user U wearing the earphone device 50 and information on the user U as an object in association with the control content of the function of the earphone device 50, and FIG. 9 shows an example thereof. Among the three items shown in FIG. 9, information on the recognized object is stored in the “object”. Further, in the “sensor detection area”, an area where the sensor unit 36 and the imaging unit 37 mounted on the AR glasses 30 can sense and image is stored. Further, in the “function control”, the control content of the function of the earphone device 50 is stored.

For example, in a case where the existence of a “human face” as an “object” is detected based on the result of sensing in front of the user U, controls of “external sound capturing”, “output stop”, and “volume reduction” are performed, as the corresponding “function control” of the earphone device 50. Further, for example, in a case where the existence of the “information processing apparatus” or the “printed matter” as the “object” is detected based on the result of sensing in front of the user U, the control of “external sound cancelling” is performed, as the corresponding “function control” of the earphone device 50. Further, for example, in a case where “object approach (regardless of type)” as the “object” is detected based on the result of sensing in the rear of or in a side direction of the user U, the controls of “external sound capturing” and “message output” are performed, as the corresponding “function control” of the earphone device 50.

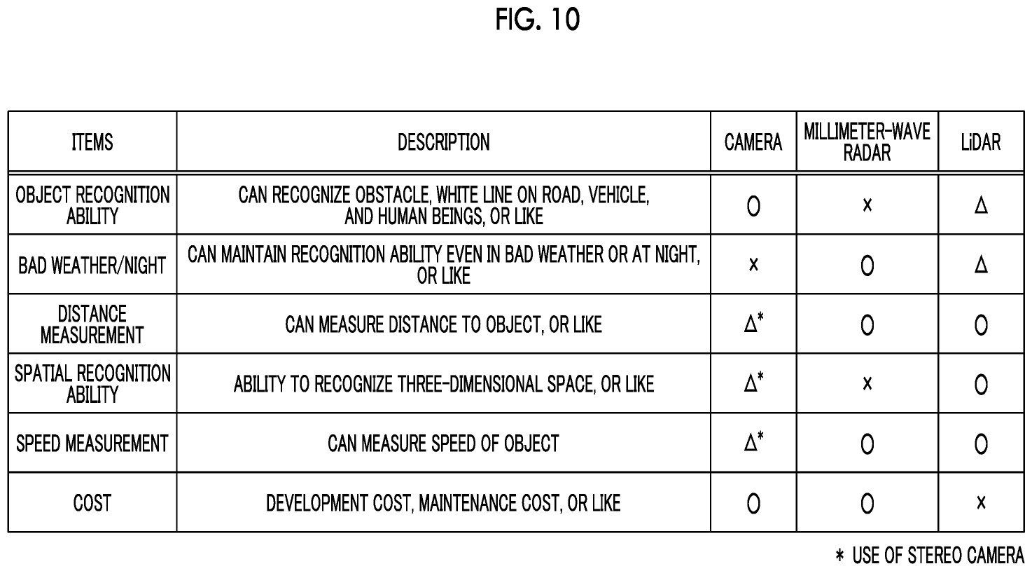

FIG. 10 is a diagram showing evaluation results regarding the ability and suitability of each of the plurality of types of sensors and cameras mounted on the sensor unit 36 and the imaging unit 37 of the AR glasses 30.

As described above, in a case of selecting the sensing result, the user terminal 10 considers an ability to recognize an object, an ability to respond to an environment, an ability to measure a distance, an ability to recognize a space, and an ability to measure a speed, or the like of each of the plurality of types of sensors and cameras mounted on the AR glasses 30. For example, the abilities shown in the “items” of FIG. 10 are considered. This makes it possible to complement each other with sensors and cameras that have strengths and weaknesses depending on the object recognition and measurement environment, and realizes more accurate object recognition.

That is, “object recognition ability” refers to the ability to recognize an object, specifically, for example, the ability to recognize obstacles, white lines on the road, vehicles, human beings, or the like that may be present around the user U. As shown in FIG. 10, the camera has a higher ability to recognize an object. In addition, “bad weather/night” refers to the ability to respond to the environment, specifically, for example, the ability to maintain recognition ability even in bad weather or at night. As shown in FIG. 10, the millimeter-wave radar has a higher ability to respond to the environment.

Further, “distance measurement” refers to the ability to measure a distance, specifically, for example, the ability to measure a distance to an object. As shown in FIG. 10, the millimeter-wave radar and LiDAR have a higher ability to measure a distance. Further, “spatial recognition ability” refers to the ability to recognize a space, and specifically, for example, the ability to recognize a three-dimensional space. As shown in FIG. 10, LiDAR has a high ability to recognize a space.

Further, “speed measurement” refers to the ability to measure a speed, specifically, for example, the ability to measure the speed of an object. As shown in FIG. 10, the millimeter-wave radar and LiDAR have a higher ability to measure a speed. Further, “cost” refers to cost performance, and specifically, for example, development cost, maintenance cost, and the like. As shown in FIG. 10, the camera and the millimeter-wave radar have a higher cost performance.

Although the present exemplary embodiment has been described above, the present invention is not limited to the above-described present exemplary embodiment. Further, the effect according to the exemplary embodiment of the present invention is not limited to the effect described in the above-described present exemplary embodiment. For example, the system configuration shown in FIG. 1 and the hardware configurations shown in FIGS. 2 and 3 are only examples for achieving the object of the present invention, and are not particularly limited. Further, the functional configurations shown in FIGS. 4 and 5 are only examples, and are not particularly limited. As long as the information processing system 1 in FIG. 1 is provided with a function capable of executing the above-described processes as a whole, the functional configuration used to implement this function is not limited to the examples of FIGS. 4 and 5.

Further, the order of the processing steps shown in FIGS. 6 to 8 is only an example, and is not particularly limited. Not only the processes are performed in chronological order according to the order of the illustrated steps, but also the processes may not necessarily be performed in chronological order and may be performed in parallel or individually. Further, the specific examples shown in FIGS. 9 and 10 are only examples, and are not particularly limited.

Further, in the above-described exemplary embodiment, the AR glasses 30 are configured to perform sensing, but the present invention is not limited to this, and for example, the earphone device 50 or the user terminal 10 may perform sensing.

Further, in the above-described exemplary embodiment, the AR glasses 30 are adopted as a wearable terminal equipped with a sensor or a camera for sensing, but the present invention is not limited to this, and any wearable terminal that the user U can wear may be equipped with a sensor or a camera to perform sensing. For example, a so-called smart watch may be made to perform sensing.

Further, for example, a sensor or a camera may be mounted on something worn by the user U to perform sensing. For example, sensors, cameras, and information transmission apparatuses may be mounted on items that user U can wear, such as users U's hats, clothes, shoulder bags, rucksacks, earrings, necklaces, and rings to perform sensing.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
manage information on an object to be recognized and control content of a function of a speaker device placed near a user's ear in association with each other; and
control the function of the speaker device, according to the control content of the function of the speaker device associated with the information on the object to be recognized, in a case where the object is recognized based on a result of sensing indicating at least one of a situation of the user or a situation around the user.

2. The information processing apparatus according to claim 1, wherein the processor is configured to:
manage, as the information on the object to be recognized, information on an object that is possibly present around the user and information on the user as the object to be recognized, and the control content of the function of the speaker device in association with each other.

3. The information processing apparatus according to claim 2, wherein the processor is configured to:
manage, as the information on the object that is possibly present around the user, information indicating a positional relationship between the user and the object, and the control content of the function of the speaker device in association with each other.

4. The information processing apparatus according to claim 3, wherein the processor is configured to:
control, in a case of recognizing the object around the user, the function of the speaker device, according to a content of at least one of control for capturing external sounds, control for cancelling external sounds, control for stopping sound output, control of adjusting a volume, or control for outputting a message indicating that the object is recognized, as the control content of the function of the speaker device associated with the information on the object.

5. The information processing apparatus according to claim 4, wherein the processor is configured to:
prioritize the capturing of external sounds, the stopping of sound output, and reducing the volume over the cancelling of external sounds, as the control of the function of the speaker device.

6. The information processing apparatus according to claim 4, wherein the processor is configured to:
perform, in a case of recognizing that a human being, as the object around the user, is present in front of the user, control of one or more of the capturing of external sounds, the stopping of sound output, or the reducing of the volume, as the control of the function of the speaker device.

7. The information processing apparatus according to claim 6, wherein the processor is configured to:
perform, in a case of recognizing that the human being, as the object around the user, is present in front of the user and speaks to the user, control of one or more of the capturing of external sounds, the stopping of sound output, or the reducing of the volume, as the control of the function of the speaker device.

8. The information processing apparatus according to claim 7, wherein the processor is configured to:
recognize that the human being speaks to the user, based on movement of a mouth of the human being as the object around the user.

9. The information processing apparatus according to claim 4, wherein the processor is configured to:
perform, in a case of recognizing that another information processing apparatus or printed matter, as the object around the user, is present in front of the user, the control for cancelling external sounds, as the control of the function of the speaker device.

10. The information processing apparatus according to claim 4, wherein the processor is configured to:
perform, in a case of recognizing that the object around the user is present in a rear of or in a side direction of the user, control of at least one of the capturing of external sounds, or the outputting of the message by sound or text, as the control of the function of the speaker device.

11. The information processing apparatus according to claim 2, wherein the processor is configured to:
manage, as the information on the user as the object, information on a behavior of the user and the control content of the function of the speaker device in association with each other.

12. The information processing apparatus according to claim 11, wherein the processor is configured to:
control, in a case of recognizing the behavior of the user, the function of the speaker device, according to a content of at least one of the control for capturing external sounds, the control for cancelling external sounds, the control for stopping sound output, the control of adjusting a volume, or the control for outputting a message indicating that the behavior of the user is recognized, as the control content of the function of the speaker device associated with the information on the behavior of the user.

13. The information processing apparatus according to claim 12, wherein the processor is configured to:
perform, in a case of recognizing turning around, looking up, or bowing, as the behavior of the user, control of one or more of the capturing of external sounds, the stopping of sound output, or the reducing of the volume, as the control of the function of the speaker device.

14. The information processing apparatus according to claim 1, wherein the processor is configured to:
recognize the object, based on a combination of a result of sensing of each of a plurality of types of sensors mounted on a wearable terminal worn by the user.

15. The information processing apparatus according to claim 14, wherein the processor is configured to:
recognize the object, based on the combination of the result of sensing and an environment in which the user uses the speaker device, which is estimated from information indicating a position of the information processing apparatus or the wearable terminal.

16. The information processing apparatus according to claim 14, wherein the processor is configured to:
recognize the object, based on the combination of the result of sensing determined based on an ability of the sensing of each of the plurality of types of sensors and an environment in which the user uses the speaker device.

17. The information processing apparatus according to claim 16,
wherein the ability is one of an ability to recognize an object, an ability to respond to an environment, an ability to measure a distance, an ability to recognize a space, or an ability to measure a speed.

18. The information processing apparatus according to claim 14, wherein the processor is configured to:
recognize the object, based on the combination of the result of sensing of each of the plurality of types of sensors mounted on a glasses-type wearable terminal mounted on the user's head.

19. An information processing system comprising:
a management unit that manages information on an object to be recognized and control content of a function of a speaker device placed near a user's ear in association with each other; and
a control unit that controls the function of the speaker device, according to the control content of the function of the speaker device associated with the information on the object to be recognized, in a case where the object is recognized based on a result of sensing indicating a situation of the user and a situation around the user.

20. A non-transitory computer readable medium storing a program causing a computer to execute:
a function of managing information on an object to be recognized and control content of a function of a speaker device placed near a user's ear in association with each other; and
a function of controlling the function of the speaker device, according to the control content of the function of the speaker device associated with the information on the object to be recognized, in a case where the object is recognized based on a result of sensing indicating a situation of the user and a situation around the user.
